(19) United States
(12) Patent Application Publication
(10) Pub. No.: US 2009/0095276 A1
(43) Pub. Date: Apr. 16, 2009

(54) Apparatus, Systems and Methods For Facilitating Ignition Of A Solid Fuel

(76) Inventor: Richard G. Kaye, Wilton, CT (US)

Correspondence Address: MCCARTER & ENGLISH , LLP STAMFORD OFFICE, FINANCIAL CENTRE , SUITE 304A, 695 EAST MAIN STREET, STAMFORD, CT, 06901-2138, US

(21) Appl. No.: 11/872,443

(22) Filed: Oct. 15, 2007

(51) Int. Cl. F24B 3/00; A47J 37/00; F23Q 13/00

(52) U.S. Cl. 126/25 B; 126/144

(57) ABSTRACT

A charcoal starter is provided that is fully consumable through combustion. The starter takes the form of a container that includes one or more walls that define a top and bottom compartment. Solid fuel is deposited in the top compartment and kindling material is deposited in the bottom compartment. The divider allows for oxygenation and ventilation while also supporting the solid fuel in the top compartment. The starter is generally composed of a cardboard or other flammable, non-toxic material. The starter is configured such that solid fuel is supported in the top compartment for a period of time after the kindling material is lit and thereafter collapses and is completely consumed. Associated methods for igniting solid fuel, e.g., charcoal, are also disclosed.

### BACKGROUND

1. Technical Field

The present disclosure relates to apparatus, systems and methods for facilitating ignition of a solid fuel. More particularly, the present disclosure relates to apparatus, systems and methods that employ a chimney or flue effect in order to ignite solid fuel, e.g. charcoal, briquettes and the like. The present disclosure also relates to portable and self-consuming apparatus/systems for facilitating the ignition of a solid fuel. Exemplary applications of the apparatus, systems and methods disclosed herein are primarily directed towards (although explicitly not limited to) ignition of charcoal and/or briquettes for grilling or other cooking purposes.

2. Background Art

It is commonly known that some solid fuels, e.g., charcoal and briquettes, require the application of an external heat source, e.g., a flame, in order to be ignited. To this end, many apparatus, systems and methods have been devised in order to cause and/or facilitate such ignition. Common apparatus, systems and methods may involve, for example, the use of a combustible “lighter” fluid, or the use of electrical heating coils. Lighter fluids, however, are known to introduce undesirable smells and aftertastes to the solid fuel being ignited, and subsequently to food cooked using such solid fuel. Electrical coils are similarly disadvantaged due to an inherently long ignition time and a general encumbrance on portability (e.g., requiring electricity to operate).

A third approach for facilitating ignition of solid fuels that is known in the art involves a chimney starter. In general application, charcoal or a similar solid fuel is positioned in an upper section of an enclosure that functions like a chimney. The fuel is generally suspended by an porous mesh, grid or other means. Paper or other easily combustible material is then positioned beneath the mesh/fuel. Thus, when the paper is ignited, the flame and hot rising air are concentrated on the solid fuel, thereby facilitating ignition. Often times, side vents are cut into the lower section of the chimney causing a flume effect that further benefits the ignition process.

Ignition of solid fuels using a chimney starter or similar device is usually much quicker than using electrical heating coils and does not result in undesirable tastes or odors that plague lighter fluid-based techniques. Despite these clear advantages, current embodiments of chimney starters have several important disadvantages which have yet to be adequately solved. For example, after the fuel is ignited, many applications require the user to lift the chimney device and pour the fuel into or onto the desired receptacle, e.g., a grill. This transfer of heated fuel is inherently hazardous to those nearby as well having a propensity to cause damage to nearby surfaces. Indeed, ash, sparks and pieces of hot fuel may be spilled during the transfer process, potentially damaging surrounding surfaces, risking fires and/or potentially burning the user. Furthermore, once the fuel has been transferred, the apparatus used to ignite the fuel is often times extremely hot and therefore hazardous. The apparatus must then be cooled (typically on a non-flammable surface), cleaned and stored for later use. These steps are time-consuming, energy-consuming and space-consuming processes.

U.S. Pat. Nos. 4,417,565, 5,197,455 and 5,197,455 provide examples of prior art chimney starters. In all three cases, the disclosed chimney starters are non-combustible, requiring the transfer of the solid fuel from the chimney starter to a final receptacle for grilling purposes and the like. Furthermore, the chimney starters are designed for subsequent cleaning and storage, with the associated disadvantages inherent therein.

U.S. Pat. No. 4,175,925 discloses a charcoal starter apparatus resembling an open box structure with a combustible bottom. According to the '925 patent, charcoal is placed within the box and ignited using a kindling wick. Once the charcoal is lit, the bottom of the box is consumed and the user may lift the remainder of the apparatus using an attached handle or strap, leaving the ignited charcoal behind. The depicted apparatus suffers from several disadvantages. For one, the apparatus lacks a compartment for kindling material, making ignition of the charcoal difficult. The apparatus also inherently includes the step of removing the apparatus by hand, wherein the handle or strap and surrounding area may be heated, sparks and ember may be flying, and smoke may be present. Furthermore, once the apparatus is removed, the charcoal may shift, causing ember and sparks to fly towards the user. Thus, the removal step presents a potentially hazardous and uncomfortable situation for the user. Also, like the previously discussed examples, it is contemplated that the disclosed apparatus will be cleaned and maintained after use, e.g., a new bottom must be attached for the next use.

U.S. Pat. No. 3,010,809 discloses a completely combustible means for facilitating ignition of charcoal. The disclosed apparatus, however, does not promote an advantageous flue effect. Furthermore, there is no separate compartment for kindling material. Indeed, the disclosed structure resembles a bag with a raised bottom, with the ignition limitations inherent therein.

Other fire-kindling devices are disclosed in U.S. Pat. Nos. 2,212,157; 3,031,277; 3,269,807; 3,167,040; 3,374,071; 4,460,377; and 4,603,679.

Despite efforts to date, a need remains for apparatus, systems and methods to more effectively facilitate ignition of solid fuels in an efficient, reliable and safe manner that overcome the limitations and/or disadvantages of currently known techniques/apparatus.

### SUMMARY

The present disclosure provides advantageous apparatus, systems and methods for facilitating ignition of solid fuel. More particularly, the present disclosure provides apparatus, systems and methods that facilitate ignition of a solid fuel using a combustible, self-consuming chimney starter. The disclosed combustible chimney starter and associated ignition methodologies facilitate efficient, reliable and safe approaches for controlled fire-based activities, e.g., grilling of foodstuffs. Moreover, the present disclosure offers significant advantages with respect to packaging, portability and convenience.

Apparatus and systems disclosed herein generally include a container defined by one or more walls that define top and bottom compartments or regions. Solid fuel is positioned or deposited in the top compartment or region and kindling material may be positioned or deposited in the bottom compartment or region. A divider is generally defined between the top compartment/region and the bottom compartment/region. Such divider is porous or otherwise structured so as to permit air/gas flow therethrough and/or thereby. Such air/gas flow allows for efficient oxygenation and/or ventilation of the solid fuel positioned in the top compartment/region. Moreover, the divider is advantageously configured and dimensioned to support the solid fuel in the top compartment/region.

The disclosed apparatus/system is generally fabricated, in whole or in part, from a combustible, non-toxic material, e.g., a cardboard and/or cardboard-based matrix of suitable rigidity and strength. Material-related parameters (e.g., composition, density, thickness and the like) of the material(s) used to fabricate the disclosed apparatus/system are generally selected so as to ensure that the apparatus/system supports the solid fuel in the top compartment/region for a sufficient period of time after the kindling material is lit. A sufficient period of time is typically defined by the period of time sufficient to facilitate sustained ignition of the solid fuel. After sustained ignition of the solid fuel is achieved, the apparatus/system (including specifically the side wall(s) and the divider) generally collapse and are consumed in flame. The disclosed apparatus/system may be advantageously fabricated as an environmentally-friendly, “green” product through appropriate selection of materials and fabrication techniques.

Methods disclosed herein facilitate sustained ignition of solid fuel, e.g., charcoal, in a reliable, efficient and safe manner. Exemplary methods according to the present disclosure include the steps of (i) providing a chimney starter apparatus/system as described herein, (ii) deploying such chimney starter apparatus/system as necessary to facilitate use thereof, and (iii) igniting kindling material so as to achieve sustained ignition of the solid fuel and the structural aspects of the chimney starter apparatus/system. Deployment of the chimney starter apparatus/system may include one or more of the following steps: (i) removing packaging/wrapping of the chimney starter/apparatus, (ii) positioning packaging/wrapping material below the divider to provide or supplement kindling material, (iii) positioning the divider/solid fuel for ignition, and/or (iv) positioning the chimney starter/apparatus relative to a final solid fuel receptacle (e.g., a grill). Of note, the disclosed methods generally relate to uses of the chimney starter apparatus/system in conjunction with an ancillary receptacle/structure for interaction with ignited solid fuel, e.g., a barbecue grill, although other ancillary receptacles/structures may be employed, e.g., a fireplace (indoor or outdoor), a campsite fire, a beach- and/or sand-based surface, etc.

In exemplary embodiments of the disclosed apparatus/system, one or more of the wall(s) that define the chimney starter container/enclosure are pierced, lanced or otherwise cut so as form one or more flaps. Generally, a multiplicity of flaps are formed from the wall(s) of the container/enclosure and such flaps are folded/pivoted inwardly relative to the center of the container/enclosure so as to define/form the divider. Exemplary flaps are configured and dimensioned so as to cooperate, when folded/pivoted inward, to support the solid fuel. Thus, the flaps may be interspersed/overlapping so as to provide enhanced support.

In exemplary embodiments of the disclosed chimney starter apparatus/system, the flaps are pre-folded to as to form a divider. In such exemplary embodiments, solid fuel may be pre-packaged and/or pre-positioned in the top compartment/region (e.g., a bag of charcoal may be included in the top compartment/region) prior to delivery to a potential user. In other exemplary embodiments of the disclosure, the flaps may be defined/formed (e.g., through lancing of the wall(s) of the container), but not yet folded inward to define/form the divider. In such exemplary implementations, an apparatus/system user may be deflect/fold the flaps inwardly to define/form the divider. Thereafter, charcoal or other suitable solid fuel may be positioned on the divider for sustained ignition, as described herein. Additional structures/components may be provided in conjunction with the inwardly deflected/folded flaps for purposes of the disclosed divider, e.g., an overlaying combustible support that further facilitates positioning of the solid fuel in the top region/compartment. The flaps may be positioned in a substantially horizontal orientation relative to the vertical wall(s) of the chimney starter apparatus/system or may be angled upwardly relative to such vertical wall(s), e.g., at an angle of about 5 to 20° relative to a horizontal plane that is orthogonal to the vertical wall(s) of the apparatus/system.

In further exemplary embodiments of the present disclosure, the inwardly folded flaps may be replaced by a distinct, combustible divider structure that is adapted for positioning within the container wall(s) and is supported in desired vertical orientation relative to the wall(s) by features defined by or supported in the wall(s). For example, the wall(s) may define a plurality of openings/slots that are adapted to receive/interact with a combustible divider structure that is introduced to the interior region of the wall(s). Alternatively, the wall(s) may define or receive circumferentially spaced, inwardly directed support elements (e.g., pegs, struts or arms) that support a combustible divider structure that rests thereupon.

Thus, the divider may be derived from the one or more walls of the container or inserted or otherwise incorporated as an additional element. Exemplary embodiments of the divider include, but are not limited to, flaps derived from the one or more walls of the container, mesh, netting, a grid, a separate platform (e.g., inserted into the container and supported by flaps acting as legs), and support structures inserted through slots in, glued to, or otherwise adhered relative to the one or more walls of the container (e.g., a flat or conical insert with tabs interlocking with pierced holes or slots in the one or more walls of the container).

In exemplary embodiments of the present disclosure, the kindling material, e.g. paper, is pre-packaged and/or pre-positioned in the bottom compartment/region before delivery to a potential user. In other exemplary embodiments, wrapping/packaging used to package the chimney starter apparatus/system may be used, in whole or in part, as the kindling material.

The geometry/configuration of the container wall(s) may take various forms, e.g., the container wall(s) may define a circular, rectangular, elliptical, hexagonal, or irregular cross-sectional geometry. In exemplary embodiments of the present disclosure, the container wall(s) may define a substantially conical shaped or be otherwise tapered so as to facilitate stacking of multiple chimney starter apparatus/systems, e.g., for storage and/or shipping purposes. The geometry/configuration of the container wall(s) may also be selected so as to facilitate the formation and/or incorporation of the divider.

Additional features, functions and benefits of the disclosed systems and methods will be apparent from the description which follows, particularly when read in conjunction with the appended figures.

### BRIEF DESCRIPTION OF THE DRAWINGS

To assist those of ordinary skill in the art in making and using the disclosed systems and methods, reference is made to the appended figures, wherein:

FIG. 1 depicts a perspective view of an exemplary apparatus, wherein the divider includes a multiplicity of flaps cut from the one or more side walls of the container.

FIG. 2 depicts a cross-sectioned side view of the apparatus depicted in FIG. 1, wherein solid fuel and kindling material are included.

FIG. 3 depicts a component that may be used to assemble an alternative embodiment of the present disclosure.

FIG. 4 depicts an assembled apparatus fabricated using components of the type depicted in FIG. 3.

### DESCRIPTION OF EXEMPLARY EMBODIMENT(S)

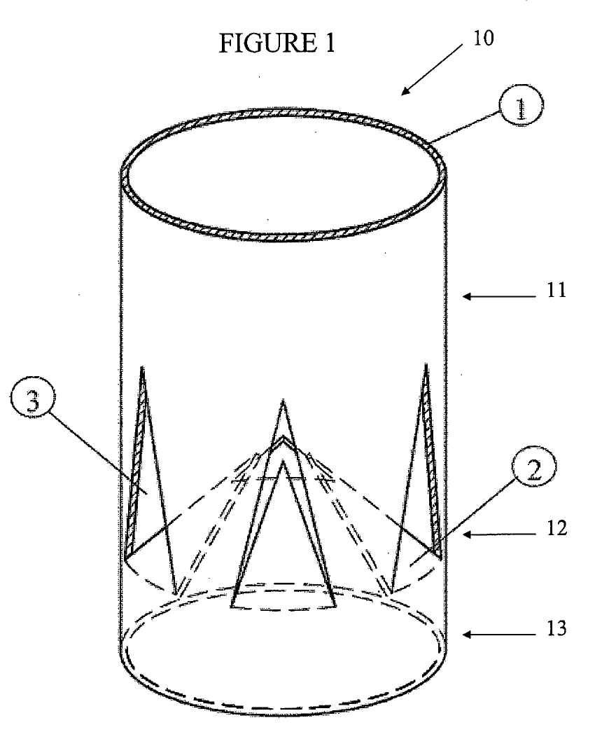

As noted above, the present disclosure provides apparatus, systems and methods that facilitate sustained ignition of solid fuel. With initial reference now to FIG. 1, a perspective view of an exemplary apparatus 10 according to the present disclosure is schematically depicted. The apparatus 10 defines an upper compartment/region 11 and a lower compartment/region 13. Upper and lower compartments/regions 11, 13 are separated by a divider 12. In general, apparatus 10 is defined by one or more side walls.

In the particular embodiment depicted in FIG. 1, apparatus 10 is defined by a single side wall 1. Side wall 1 is configured and dimensioned such that the apparatus 10 defines a substantially tubular structure. Apparatus 10, however, may include any number of side walls and may be configured to define substantially any geometry provided that an internal conduit/passage is defined for function as a flue. Exemplary side wall configurations include, but are not limited to, a circular side wall configuration, an ovular side wall configuration, a triangular side wall configuration, a rectangular side wall configuration, an hexagonal side wall configuration, an elliptical side wall configuration, an irregular side wall configuration, etc.

In exemplary embodiments, the disclosed apparatus is configured so as to define a substantially conical (or otherwise tapered) geometry, e.g., through a narrowing cross-section from the bottom to top (or vice versa), so as to promote stacking/storage of two or more apparatus and/or to influence gas flow therethrough. Apparatus 10 may also be tapered or otherwise configured around divider 12 so as to facilitate dividing the structure into two compartments, as described herein.

In the exemplary embodiment of FIG. 1, the divider 12 includes a multiplicity of tabs/flaps 2 that are lanced from the side wall 1 and bent into/toward the center thereof so as to form conically-shaped divider 12. The divider 12 acts as a platform to support a solid fuel, e.g., charcoal or briquettes (not pictured). The number, shape and relative position of tabs/flaps 2 may vary depending on various factors, e.g., the characteristics of the solid fuel (e.g., size of individual fuel pieces), desired strength/rigidity of the divider, desired strength/rigidity of the container wall(s), and performance standards. In general, the divider 12 is configured such that it supports a solid fuel in the upper compartment/region 11 while promoting oxygenation, i.e., air-flow and ventilation, for sustained ignition thereof. In the exemplary embodiment of FIG. 1, ventilation holes 3 are defined in the side wall 1 by lancing and inward folding/deflection of tabs/flaps 2 from the side wall 1. The ventilation holes 3 provide a means for air to be drawn into the container to facilitate ignition and subsequent combustion of the solid fuel and the container itself.

Although the divider 12 is formed using tabs 2 in the exemplary embodiment depicted in FIG. 1, many other configurations can likewise be used to form the divider 12 of the present disclosure. Exemplary embodiments of the divider 12 include, but are not limited to, flaps derived from the one or more walls of the container 10 (as is depicted in FIG. 1), a mesh supported with respect to the wall(s) of the container, netting supported with respect to the wall(s) of the container, a grid supported with respect to the wall(s) of the container, a separate platform supported with respect to the wall(s) of the container (e.g., inserted into the container and supported by inwardly directed struts, pegs or legs), and/or alternative support structures that are inserted through slots in, are glued to, and/or are otherwise supported/adhered relative to the one or more walls of the container (e.g., a flat or conical insert with tabs interlocking with pierced holes or slots in the one or more walls of the container).

Similarly, ventilation holes or shafts, e.g., ventilation holes 3, may be employed and/or embodied in various configurations, sizes and locations. For example, tabs/flaps 2 may be lanced from the side wall 1 and folded inward to form ventilation holes relative to the lower compartment 13, rather than the upper compartment 11 as depicted in FIG. 1. An inner ventilation shaft, e.g., a tube or other conduit, may be included through the center of apparatus 10 running along the axis thereof, e.g., forming a tube within a tube structure. The inner ventilation shaft may be pierced or lanced intermittently so as to further promote ventilation and oxygenation.

In exemplary embodiments of the present disclosure, the disclosed apparatus/system may be provided to a potential user with the divider preformed. In alternate implementations, the divider may be only partially formed at the top of delivery to a user, and the user may be required to complete assembly/formation thereof. Thus, for example, tabs/flaps 2 may be perforated but not yet folded inward relative to wall 1. Assembly 10 may similarly require assembly prior to use, e.g., by folding and/or connecting the side walls, etc.

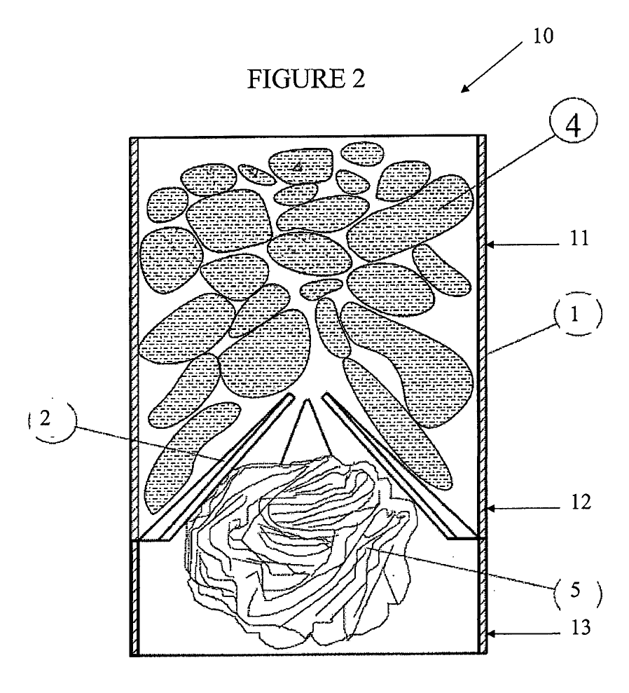

With reference to FIG. 2, a cross-sectional side view of the exemplary apparatus 10 of FIG. 1 is schematically depicted. Apparatus 10 is divided by divider 12 into upper compartment/region 11 and lower compartment/region 13. The outer periphery of apparatus 10 is formed/defined by wall 1. Divider 12 is formed by the inward deflection of tabs/flaps 2 relative to wall 1. In the exemplary embodiment depicted in FIG. 2, a solid fuel 4, e.g. charcoal or briquettes, is included/positioned in the upper compartment/region 11, and kindling material 5, e.g., paper or other easily combustible material, is included/positioned within the lower compartment/region 13. The solid fuel 4 may also include, in whole or in part, wood chips, cut wood and/or wood elements of appropriate size/shape. Indeed, in exemplary embodiments of the present disclosure, wood chips selected to impart desirable “smoke flavoring” to grilled food products may be provided for use in the disclosed apparatus 10. Such wood chips may be provided in one or more separate packets/enclosures for use in apparatus 10, as and when desired.

In exemplary implementations of the present disclosure, apparatus 10 may be obtained by the user with the solid fuel 4 and/or the kindling material 5 already included/positioned in the appropriate compartments. In other implementations, apparatus 10 may be obtained as a kit, wherein solid fuel 4 and/or kindling material 5 is included, but must be loaded into the appropriate compartment(s) by the user. In further embodiments of the present disclosure, solid fuel 4 and/or kindling material 5 is independently obtained and introduced to the apparatus/system by the user prior to use thereof. In exemplary embodiments, packaging paper or other packaging material included with the apparatus may be used, in whole or in part, as the kindling material 5. An ignition source, e.g., matches, lighter or the like, may be included with the disclosed apparatus/kit to further facilitate use and convenience thereof.

Once apparatus 10 is fully assembled, i.e., solid fuel and kindling material are positioned in the requisite compartments/regions, ignition of the solid fuel is advantageously facilitated. Generally, the apparatus 10 is first positioned relative to a desired final receptacle for the solid fuel, e.g., a grill. Once the apparatus 10 is properly set-up/positioned, the user lights/ignites the kindling material contained/positioned in the lower compartment/region. In exemplary embodiments of the disclosure, a wick, fuse or other means may be used to facilitate lighting of the kindling material. In further exemplary embodiments, a lighting mechanism associated with the final receptacle may be used to light the kindling material. Once the kindling material is lit, heat and flame from the kindling material are focused up through the divider and towards the solid fuel. As the heat and flames are focused on the solid fuel, the temperature rises within the container, eventually igniting the solid fuel and igniting/consuming the apparatus itself.

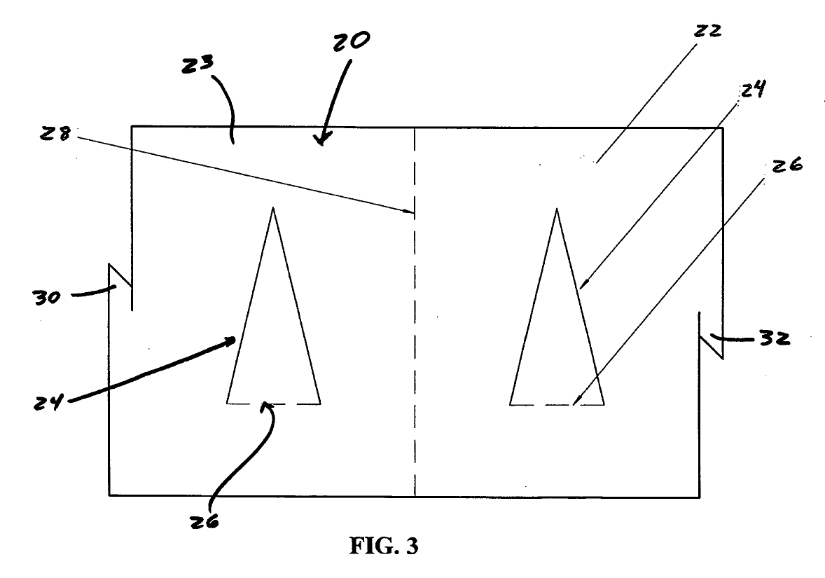

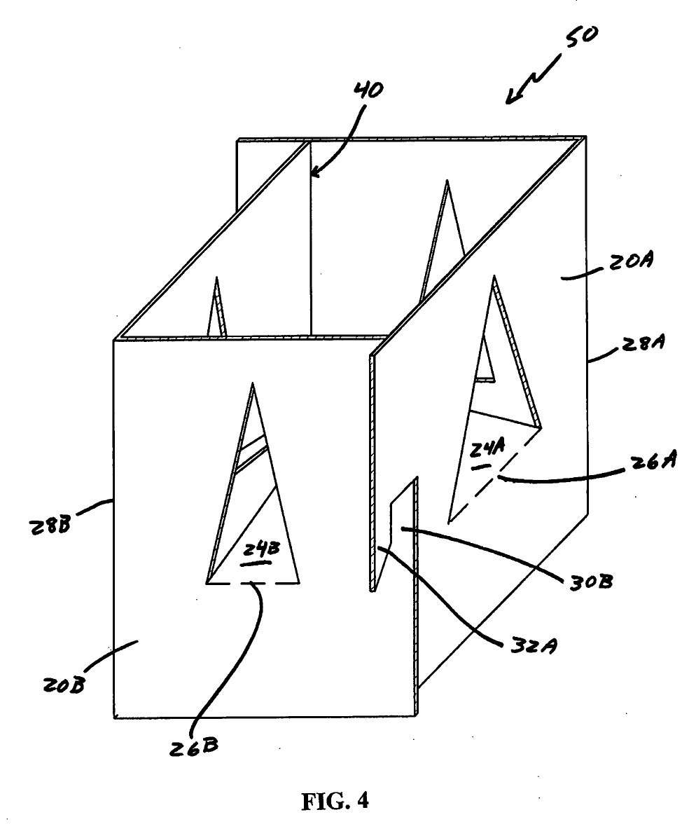

Turning to FIGS. 3 and 4, an alternative apparatus 50 of two-part construction, thereby facilitating storage and shipment in flat/stacked orientation. More particularly, with initial reference to FIG. 3, a first wall component 20 includes a pair of substantially triangular divider elements 24 formed on either side of a creased fold-line 28. The first and second divider elements 24 are formed in wall regions 22, 23, respectively, and are each adapted to be folded relative to fold-lines 26. Oppositely directed engagement flaps 30, 32 are formed with respect to the edges of wall regions 23, 22, respectively. Triangular divider elements 24 and engagement flaps 30, 32 are generally die-cut with respect to the wall regions 22, 23.

A pair of identical wall components 20A, 20B may be used to assemble apparatus 50, as shown in FIG. 5. More particularly, wall component 20A is folded relative to fold-line 28A and wall component 20B is folded relative to fold-line 28B. Opposed engagement flaps 30A/32B and 30B/32A are brought into engagement to define a substantially rectangular apparatus 50 from L-shaped wall components 20A, 20B. So oriented, wall components 20A, 20B generally engage along a pair of interface lines 40 (only one of which is clearly visible in FIG. 4). In addition, dividers 24A, 24B are folded inward relative to fold-lines 26A, 26B, respectively, to define upper and lower compartments within apparatus 50. The inwardly folded dividers 24A, 24B facilitate the introduction, support and ignition of solid fuel (as described in greater detail with reference to FIGS. 1 and 2). Moreover, apparatus 50 is adapted to be fully combusted in the manner described with reference to apparatus 10 of FIGS. 1 and 2.

Many variations on the two-piece assembly of FIGS. 3 and 4 may be implemented. For example, alternative engagement structures/mechanisms may be utilized to engage/interlock individual wall components, e.g., tongue-in-groove type assemblies. In addition, alternative divider geometries may be employed, e.g., trapezoidal, arcuate and/or rectangular geometries. Still further, the edges of the wall components may be angularly oriented such that the assembled apparatus defines an inwardly-sloped structure. The two-piece assembly of FIGS. 3 and 4 offers many advantages in practice, particularly as relates to manufacture, assembly, storage and shipping.

The entire apparatus is generally made of cardboard and/or other flammable, non-toxic materials. Thus, an exemplary adhesive for use in fabricating the wall(s) of the apparatus is a sodium silicate glue that is GRAS (Generally Regarded As Safe) by the FDA. Furthermore, the composition, density and thickness of the material is selected such that the apparatus is able to support a solid fuel in the top compartment/region for a period of time that is sufficient to facilitate sustained ignition of the solid fuel. Thus, the apparatus may be made of, by way of example only, recycled spiral wound paperboard with a density of about 0.025-0.030 lbs per cubic inch and a wall thickness of approximately 0.18 to 0.2 inches. Once sufficient time has lapsed for the solid fuel to achieve sustained ignition, the apparatus generally collapses and is completely consumed, thus depositing the ignited solid fuel into the desired receptacle.

The presently disclosed apparatus, systems, and methods have many clear advantages over prior art designs and techniques. The consumable nature of the disclosed apparatus eliminates the potentially hazardous and undesirable step of transferring ignited solid fuel from a traditional chimney starter into a final receptacle. The consumable nature of the apparatus also eliminates the need for cleanup and storage after use. Furthermore, the apparatus is relatively inexpensive, easy to use and readily transportable.

Although the present disclosure has been described with reference to exemplary embodiments and implementations thereof, the disclosed systems and methods are not limited to such exemplary embodiments/implementations. Rather, as will be readily apparent to persons skilled in the art from the description provided herein, the disclosed systems and methods are susceptible to modifications, alterations and enhancements without departing from the spirit or scope of the present disclosure. Accordingly, the present disclosure expressly encompasses such modification, alterations and enhancements within the scope hereof.

What is claimed is:

1. Apparatus for facilitating ignition of a solid fuel, wherein the apparatus comprises
a. a combustible container defined by one or more walls;
b. a combustible divider supported with respect to the one or more walls, said divider defining an upper region and a lower region within the container;
wherein the combustible divider is formed at least in part by inward deflection of one or more lanced or die-cut portions of the one or more walls of the container.

2. The apparatus according to claim 1, wherein the container defines a substantially conical configuration to facilitate stacking thereof.

3. The apparatus according to claim 1, further comprising a solid fuel positioned in the upper region and supported by the combustible divider.

4. The apparatus according to claim 3, wherein the solid fuel is selected from the group consisting of charcoal, briquettes, wood chips, cut wood, and combinations thereof.

5. The apparatus according to claim 1, wherein the apparatus is prepackaged with at least one of (i) solid fuel positioned in the upper compartment, and (ii) combustible kindling material associated with the container.

6. The apparatus according to claim 5, wherein the combustible kindling material is at least in part packaging that initially encloses the container.

7. The apparatus according to claim 1, wherein the divider comprises one or more flaps cut from the one or more walls of the container and folded in towards the center of the container

8. The apparatus according to claim 1, wherein the divider comprises one or more structural elements supported by inward projections from the one or more side walls of the container.

9. The apparatus according to claim 1, wherein the divider further comprises at least one of: (i) a mesh, (ii) a grid, and (iii) a net.

10. The apparatus according to claim 1, wherein the one or more walls define ventilation holes adjacent the one or more inwardly deflected lanced portions.

11. The apparatus according to claim 1, further comprising a perforated ventilation shaft through the center of the container running along the axis of the container.

12. The apparatus according to claim 1, wherein the combustible container is a two-piece assembly.

13. The apparatus according to claim 12, wherein the two-piece assembly includes first and second wall members that include interlocking features along edges thereof.

14. The apparatus according to claim 12, wherein the two-piece assembly is adapted for shipment and storage in a substantially flat orientation prior to assembly thereof.

15. A method for facilitating ignition of a solid fuel, the method including the steps of:
a. providing an apparatus for facilitating ignition of a solid fuel, the apparatus including (i) a combustible container defined by one or more walls, and (ii) a combustible divider supported with respect to the one or more walls, wherein the divider defines an upper region and a lower region within the container and is formed at least in part by inward deflection of one or more lanced portions of the one or more walls of the container;
b. positioning said apparatus relative to a final receptacle;
c. igniting kindling material positioned within the lower region of the container so as to achieve sustained ignition of solid fuel positioned in the upper region of the container and combustion of the container itself.

16. The method according to claim 15, wherein ignition of the kindling material is facilitated by a wick or fuse.

17. The method according to claim 15, wherein the final receptacle is a grill.

18. The method according to claim 15, further comprising removing packaging from the container and using the packaging as kindling material.

19. The method according to claim 15, wherein the solid fuel is charcoal.

20. Apparatus for facilitating ignition of a solid fuel, wherein the apparatus comprises
a. a combustible container defined by one or more walls;
b. a combustible divider supported with respect to the one or more walls, said divider defining an upper region and a lower region within the container.
